(19) United States
(12) Patent Application Publication
(10) Pub. No.: US 2007/0217393 A1
(43) Pub. Date: Sep. 20, 2007

(54) Message System

(75) Inventors: Francis Yew Hong Lee, Singapore (SG); King Hoe Goh, Singapore (SG); Jiayi Alex Wang, Shenzhen (CN); Chun Yan See, Singapore (SG); Antonius Ng, Singapore (SG)

Correspondence Address: WELLS ST. JOHN P.S., 601 W. FIRST AVENUE, SUITE 1300, SPOKANE, WA, 99201, US

(73) Assignee: STARHUB LTD, Singapore (SG)

(21) Appl. No.: 10/565,313

(22) PCT Filed: Jul. 16, 2004
(86) PCT No.: PCT/SG04/00215

§ 371 Date: May 25, 2007

(30) Foreign Application Priority Data
Jul. 18, 2003 (SG) 200303726-4

(51) Int. Cl. H04L 12/66

(52) U.S. Cl. 370/352

(57) ABSTRACT

A method of two-way communication between a web browser and a mobile telecommunication device including the steps of; accessing a web-site via a computer, sending a message to a mobile telecommunication device from the web-site, and at a message server capturing information uniquely identifying the computer, assigning an identification number to the information uniquely identifying the computer, storing the identification number and information uniquely identifying the computer in a database, and sending the message to the mobile telecommunication device with the identification number.

### FIELD OF INVENTION

The invention relates to a system for communication between an Internet browser and a mobile telecommunication device.

### BACKGROUND

Currently mobile phone subscribers can send and receive SMS (short message service) or MMS (multimedia message service) messages to and from other mobile phone users. This two-way messaging is only available to mobile phone subscribers through mobile telecommunication devices.

One-way messaging is also available between a sending party using an Internet enabled device via a web browser and a receiving mobile phone subscriber. The sender of the message uses a telecommunication service provider to send the SMS or MMS message to the mobile telecommunication device subscriber. No reply can be sent to the Internet browser from tie mobile telecommunication device.

Several systems have been proposed to overcome this problem.

U.S. Pat. No. 6,178,331 describes a bi-directional multiplexing messaging gateway for wireless devices such as mobile phones. The patent describes that when a message is sent from an outside email source the gateway may create a new temporary MSISDN number associated with the reply address before sending the message and reply MSISDN to the mobile phone. The user of the mobile phone can then reply to the message and the MSISDN is sent back to the gateway with the reply message. The gateway then maps the MSISDN back to the address of the original sender. However, this system requires that the sender have an email address. The system does not work when the sender doesn't have an email address.

U.S. Pat. No. 6,085,100 describes a system for sending and receiving short messages. When an external device is used to send an SMS to a mobile phone, the SMS is first routed through a gateway. The gateway stores in a database the address to which the SMS is being sent, a time stamp and the address of the external device. When the mobile phone user replies to the message it is sent back to the gateway with the timestamp. The gateway uses a combination of the time stamp and the destination address of the mobile phone to search the database and find the address of the external device. The reply is then sent on to the external device. This system is more complex and relies on the use of date and time stamping to identify the originating device. If two or more messages are sent to the same mobile subscriber within a second the system will not be able to determine to which sender to a response should be directed. Another disadvantage is that the temporary source address, as a combination of Gateway Application address, date, and time stamp could be very long. The address may be too long for the SMS message signal to accommodate and will not work for Internet SMS.

PCT patent publication WO 02/058356 describes a method for sending MMS messages between mobile phones via the Internet. The originating mobile phone is connected to the Internet via a public land mobile network (PLMN). When the originating mobile phone sends an MMS message to a receiving mobile phone, the message is first routed to an MMS server. The message lists the receiving mobile phone by its MSISDN number (essentially the phone number of the mobile phone). The message server sends a notification message to a PAP server. The PAP server determines whether the receiving mobile phone is currently communicating with the Internet. If the receiving device is communicating with the Internet the PAP server sends the receiving mobile notification that there is an MMS message at the MMS server. If the receiving device is communicating with the Internet via a different PTMN than that which is being used by the originating mobile phone, or the receiving mobile phone is not communicating with the Internet, the MMS server sends an SMS to the receiving mobile using the MSISDN number of the receiving mobile. This invention will only work between two mobile devices with existing MSISDN numbers. It is not suitable for communication between mobile phones and web browsers.

### SUMMARY OF INVENTION

It is the object of this invention to provide a method of two-way communication between a web browser and a mobile telecommunication device or to at least provide the public with a useful choice.

In broad terms in one aspect the invention comprises a method of two-way communication between a web browser and a mobile telecommunication device including the steps of; accessing a web-site via a computer, sending a message to a mobile telecommunication device from the web-site, and at a message server capturing information uniquely identifying the computer, assigning an identification number to the information uniquely identifying the computer, storing the identification number and information uniquely identifying the computer in a database, and sending the message to the mobile telecommunication device with the identification number.

Preferably the method of two-way communication further includes the step of capturing the receiving mobile telecommunication device number at the message server.

Preferably the message server further includes the step of sending an acknowledgement to the web-site. The acknowledgement may include instructions to keep the web-site open in order to receive replies from the mobile telecommunication device.

Preferably the name of the sender is appended to the message sent to the mobile telecommunications device. The name of the sender is generally appended to the message by the web server.

In broad terms in another aspect the invention comprises a message server arranged to capture information uniquely identifying a computer sending a message to a mobile telecommunication device via a web-site, capture the message sent by the computer, assign an identification number to the information uniquely identifying the computer, store the identification number and information uniquely identifying the computer in a database, and send the message to the mobile telecommunication device with the identification number.

Preferably the message server is further arranged to capture the receiving mobile telecommunication device number.

Preferably the message sever is further arranged to an acknowledgement to the web-site. The acknowledgement may include instructions to keep the web-site open in order to receive replies from the mobile telecommunication device.

Preferably the web site is provided by a telecommunication service provider..

The message server may further be arranged so that upon receipt of a message from a mobile telecommunication device sent with an identification number of the message server, capture the message, identification number, and the receiving mobile telecommunication device number, use the database to match the identification number to information uniquely identifying a computer and the receiving mobile telecommunication device number, and send the message to the computer with the matching unique identifying information.

### BRIEF DESCRIPTION OF DRAWING

The invention including a preferred font thereof will be further described with reference to the accompanying figure in which;

FIG. 1 shows a communication system for communication between a web site and a mobile telecommunication device.

### DETAILED DESCRIPTION

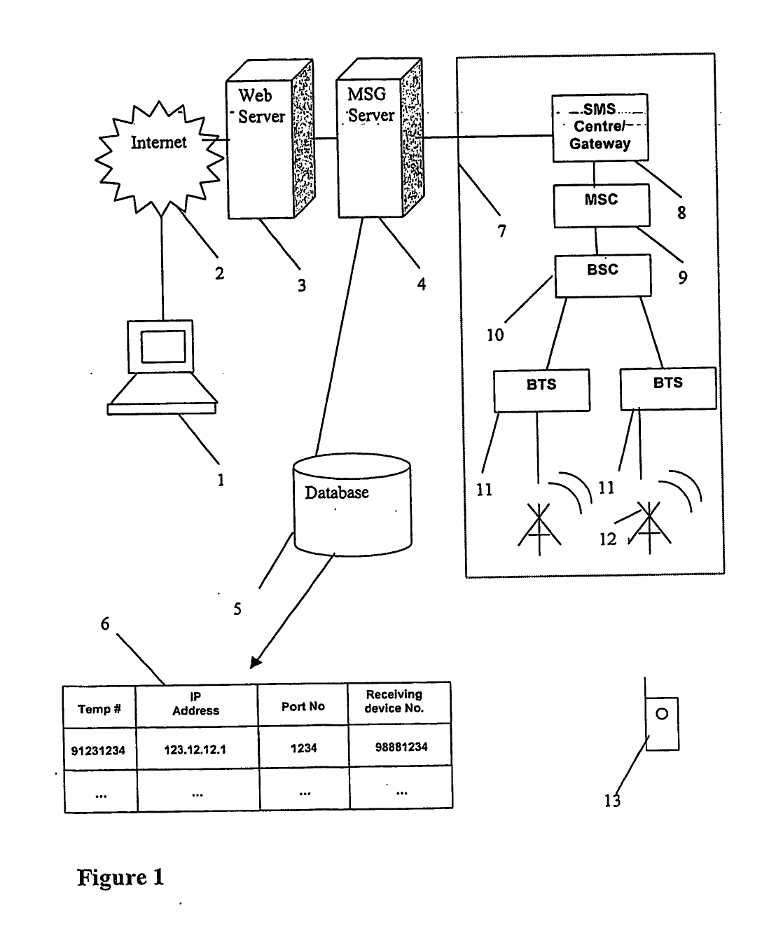

FIG. 1 shows a communications system of the invention. The communications system includes a computer 1 connected to the Internet 2. Web server 3 is also connected to the Internet. Web server 3 is further connected to message server 4. Message server 4 includes database 5 and translation table 6. Message server 4 is connected to telecommunication network 7. Telecommunication network 7 includes SMS Centres/Gateways 8, Mobile Switching Centres (MSC) 9, Base Station Controllers (BSC) 10, Base Transceiver Stations (TS) 11 and cell phone towers 12.

A user wishing to send a message via the Internet to a mobile telecommunication device accesses the Internet 2 using computer 1. The user accesses a web site via the Internet. The web site may be stored on web server 3. Using the web site the user types a message to be sent to a mobile telecommunication device as well as the phone number of the mobile telecommunication device. When the user has finished writing the message the user selects a send function on the web site. The message is then sent from the web server 3 to message server 4. The user may use the web site to send messages to different mobile telecommunication devices. Each different mobile telecommunication device to which the web site user sends messages can be considered a different session and may appear in different windows. Either the same or different identification numbers can be used for each session.

Upon receipt of a message from web server 3, message server 4 captures the information uniquely identifying computer 1. This information may include (but is not limited to) the computer IP address, port number and a cookie. Database 5 and translation table 6 are queried to check if any identification number has been assigned to the captured unique identifying information of computer 1. If no identification number has been assigned to the captured unique identifying information an identification number is then assigned. The identification number, IP address computer 1 and information uniquely identifying computer 1 are then stored in message database 5 and translation table 6.

An advantage of using identification numbers instead of telephone numbers is that no number from a pool of available telephone number is required to be assigned to a session. This leads to more efficient use of resources as the message sent from the message server to a mobile telecommunication device may use a different phone number each time. To reply, the mobile telecommunication device user selects a reply function of the mobile telecommunication device. In one embodiment the reply function automatically includes the identification number in the reply. In another embodiment the mobile telecommunications device user enters the identification number as part of the reply message.

The temporary identification number may include an application identification portion and a user identification portion. The application identification portion can be used to identify the message server from where the sent message originated and which includes the database identifying the sending computer. The second portion of the identification number, i.e. the user ID portion, may identify the message server record with the unique data identifying the sending computer. In preferred embodiments the second portion of the identification number is in no way related to the information uniquely identifying the computer so that the sending computer cannot be identified from the identification number but only via the message server database.

In one preferred embodiment message server 4 also captures the receiving mobile telecommunication device number and stores this information with the captured IP address and port number of the originating device. In this embodiment database 5 and translation table 6 are queried to check if any identification number has been assigned to the information uniquely identifying the computer and receiving mobile telecommunications device number.

In the preferred embodiment if there is no identification number assigned to the information uniquely identifying the computer and receiving mobile telecommunication device number an identification number is assigned and the information uniquely identifying the computer is stored along with the phone number of the receiving mobile telecommunication device.

In a further alternative embodiment the message server 4 captures the information uniquely identifying computer 1 and the receiving mobile telecommunication device number. In this embodiment database 5 and translation table 6 are queried to check if any identification number has been assigned to the information uniquely identifying the computer. In this embodiment the receiving mobile telecommunications device number is capture but not used to determine whether an identification number has been assigned to the originating computer 1.

If there is no identification number assigned to the information uniquely identifying the computer, an identification number is assigned and the information uniquely identifying the computer is stored along with the phone number of the receiving mobile telecommunication device.

The message received by message server 4 is then sent to telecommunication network 7 with the assigned identification number. The identification number is currently assigned to the information uniquely identifying the computer (and in the preferred embodiment the receiving mobile telecommunication device number) the message is sent to telecommunication device 13 with the currently assigned identification number.

The message server may also send an acknowledgement to computer 1 that the message has been and that the web-site should be kept open in order to receive any reply from the mobile telecommunication device.

When the message server 4 is set up a number of telephone numbers may be assigned to the message server by a telecommunication service provider. For example the message server may be provided with a list of 10,000 identification numbers. Each of these identification numbers can be assigned as an identification number for a device attached to the Internet. The number of identification numbers assigned to the message server may be based on the estimated number of messages simultaneously using the message server and the estimated average length of use of an identification number by an Internet device.

If all the identification numbers have been assigned the message server may search the database and find an identification number that can be reassigned. Assigning an identification number may be on the basis of reassigning the identification number that was the earliest to be assigned. Alternatively the database may include a time stamp of the latest time a message was sent either to or from a computer identified by unique identifying information and receiving mobile telecommunication device number assigned to an identification number. The message server 4 may then select the identification number with the longest time since last use on the assumption that it is no longer in use. Alternatively, all identification numbers exceeding a pre-specified time limit, for example 24 hours, will be reused.

To assist in the availability of identification numbers, when a user using a web site to send messages to a mobile device closes the web site a message may be sent to the message server that the identification number is no longer needed and the identification number may be added to the pool of available identification numbers.

Telecommunication network 7 delivers the message and identification number to mobile telecommunication device 13. The user of the mobile telecommunication device can then reply to the message using the reply function on the mobile telecommunication device and including the identification number in the message as the user will normally do with the current SMS or MMS procedure.

When the user of the mobile telecommunication device 13 replies to the message, the message from the mobile telecommunication device passes through telecommunication network 7 to MSC 9. MSC 9 recognises the phone number to which the message is sent as belonging to message server 4 and directs the message to message server 4.

Message server 4 looks up the identification number using message database 5 and translation table 6. If information uniquely identifying a computer is found assigned to the identification number the message server directs the message to the uniquely identified computer.

If no information uniquely identifying a computer is assigned to the identification number the message server may send a message back to the mobile telecommunication device 13 advising that the message is undeliverable.

In the preferred embodiment, message server 4 looks up the identification number using message database 5 and translation table 6. If information uniquely identifying a computer and receiving mobile telecommunication device number are found assigned to the identification number the message server directs the message to the computer identified by the unique identifying information.

If no information uniquely identifying a computer and receiving mobile telecommunication device number are assigned to the identification number the message server may send a message back to the mobile telecommunication device 13 advising that the message is undeliverable.

Because any reply messages are sent to the web site accessed by the user and the uniquely identified computer, a computer user must keep the web site open to receiving any incoming messages. A message to this effect may be displayed on the web site. Alternatively when the message server acknowledges that a message has been received it may also send a reminder to keep the web site open to receive any replies. When the user ends a session a message may be sent to the mobile user alerting them to the end of session. The session will end when the user closes or otherwise leaves the website.

In one embodiment when the web site user is a subscriber to the web site (or to the company that runs the web site) the user enters a login and password to enter the site. This information is stored by the message, server along with the information uniquely identifying the computer used by the user. The message server then has a record of the user and the computer used by the user. The user sends messages via the web site to mobile telecommunications devices that may be anywhere in the world. The user can also select where a reply is to be sent. For example the user may select that replies are sent to an inbox or mobile device. In another embodiment the user may still be logged into the website and may elect to receive replies at a different device or address. In preferred embodiments the different devices use the same telecommunications company as the web site or telecommunications companies in partnership with the company running the website.

In another embodiment the web site user is not a subscriber to the web site or to the company that runs the website. The web site user can use the web site to send messages to customers of telecommunications companies partnered with the company operating the web site or to customers of the telecommunications company that operates the web site. In this embodiment information uniquely identifying the computer is stored in the message server and the message and identification number is sent to the mobile telecommunications device. No information identifying the user of the computer is stored.

The foregoing describes the invention including a preferred form thereof. Alterations and modifications as will be obvious to those skilled in the art and intended to including in the scope hereof as defined by the accompanying claims.

1. A method of two-way communication between a web browser and a mobile telecommunication device including the steps of;
accessing a web-site via a computer,
sending a message to a mobile telecommunication device from the web-site, and
at a message server capturing information uniquely identifying the computer, assigning an identification number to the information uniquely identifying the computer, storing the identification number and information uniquely identifying the computer in a database, and sending the message to the mobile telecommunication device with the identification number.

2. A method of two-way communication between a web browser and a mobile telecommunication device as claimed in claim 1 wherein a set number of identification numbers are available for assigning by the message server.

3. A method of two-way communication between a web browser and a mobile telecommunication device as claimed in claim 1 or claim 2 further including the step of capturing the receiving mobile telecommunications device number at the message server.

4. A method of two-way communication between a web browser and a mobile telecommunication device as claimed in claim 3 further including the step of storing the receiving mobile telecommunication device number in the message server database.

5. A method of two-way communication between a web browser and a mobile telecommunication device as claimed in claim 4 wherein the identification number is not related to the information uniquely identifying the computer and the receiving mobile telecommunication device number.

6. A method of two-way communication between a web browser and a mobile telecommunication device as claimed in any one of claims 1 to 5 wherein the identification number includes a portion identifying the message server.

7. A method of two-way communication between a web browser and a mobile telecommunication device as claimed in claim 6 the method further including the steps of;
at the message server receiving a message from a mobile telecommunication device with an identification number of the message server, capturing the message and identification number, using the database to match the identification number to information uniquely identifying a computer, and sending the message to the computer identified by the unique identification information.

8. A method of two-way communication between a web browser and a mobile telecommunication device as claimed in claim 7 further including the step of at the message server capturing the receiving mobile telecommunication device number.

9. A method of two-way communication between a web browser and a mobile telecommunication device as claimed in claim 8 further including the step of at the message server using the database to match the identification number to information uniquely identifying a computer and to the receiving mobile telecommunication device number.

10. A method of two-way communication between a web browser and a mobile telecommunication device as claimed in any one of claims 1 to 9 further including the step of sending an acknowledgement message to the web browser when a message is received by the message server.

11. A method of two-way communication between a web browser and a mobile telecommunication device as claimed in any one of claims 1 to 10 further including the step of after the message server receives a message from the web browser the message server sends a message to the web browser informing the user of the web browser that to receive a response the web browser must remain open.

12. A method of two-way communication between a web browser and a mobile telecommunication device as claimed in any one of claims 1 to 11 further includes the step of informing a mobile telecommunication device user when the web browser user ends a session.

13. A message server arranged to;
capture information uniquely identifying a computer sending a message to a mobile telecommunication device via a web site,
capture the message sent by the computer,
assign a identification number to the information uniquely identifying the computer;
store the identification number and information uniquely identifying the computer in a database, and
send the message to the mobile telecommunication device with the identification number.

14. A message server as claimed in claim 13 wherein the web site is provided by a telecommunication service provider.

15. A message server as claimed in claim 13 or claim 14 wherein a set number of identification numbers are available for assigning by the message server.

16. A message server as claimed in any one of claims 13 to 15 wherein the message server is further arranged to capture the receiving mobile telecommunications device number.

17. A message server as claimed in claim 16 further arranged to store the receiving mobile telecommunication device number in the message server database.

18. A message server as claimed in claim 17 further arranged to assign the identification number unrelated to the information uniquely identifying the computer and the receiving mobile telecommunication device number.

19. A message server as claimed in any one of claims 13 to 18 wherein the message server is further arranged so that upon receipt of a message from a mobile telecommunication device sent to a identification number of the message server;
captures the message and identification number,
uses the database to match the identification number to information uniquely identifying a computer, and
sends the message to the computer identified by the unique identifying information.

20. A message server as claimed in claim 19 further arranged to capture the receiving mobile telecommunication device number.

21. A message server as claimed in claim 20 further arranged to use the database to match the identification number to information uniquely identifying a computer and the receiving mobile telecommunication device number.

22. A message server as claimed in any one of claims 13 to 21 further arranged to send an acknowledgement message to the web browser when a message is received by the message server.

23. A message server as claimed in any one of claims 13 to 22 further arranged to send a message to the web browser informing the user of the web browser that to receive a response the web browser must remain open after the message server receives a message from the web browser the message server.
